(19) United States
(12) Patent Application Publication
(10) Pub. No.: US 2021/0356050 A1
(43) Pub. Date: Nov. 18, 2021

(54) RELIEF VALVE

(71) Applicant: Takehiko NAIKI, (US)

(72) Inventor: Takehiko NAIKI, (US)

(21) Appl. No.: 16/319,107

(22) PCT Filed: Feb. 8, 2018
(86) PCT No.: PCT/JP2017/026986

§ 371 Date: Jan. 18, 2019

(51) Int. Cl. F16K 17/06

(52) U.S. Cl. CPC F16K 17/065

(57) ABSTRACT

A relief valve of the present invention includes a valve housing (1) including an inlet (13) into which a fluid is introduced, a valve sliding path (3) extending from the inlet (13), and a release port (15) provided in a wall surface of the valve sliding path (3), a valve piston (21) slidably housed in the valve sliding path (3) while being pressed toward an inlet side, the valve piston (21) opening and closing the release port (15), and a valve stopper (37) provided in the inlet (13) to cross an end surface of the valve piston (21) in a slender shape, receiving and stopping the pressed valve piston (21), and disposing the valve piston (21) in a position where the valve piston closes the release port (15).

### TECHNICAL FIELD

The present invention relates to a relief valve, and particularly to a relief valve used for preventing an abnormal rise in hydraulic pressure, keeping hydraulic pressure at predetermined hydraulic pressure or the like.

### BACKGROUND ART

An engine, for example, an engine of an outboard motor is provided with a relief valve at a downstream side (discharge side) of an oil pump incorporated into the engine, and prevents hydraulic pressure of oil (fluid) that is supplied to respective parts of the engine from abnormally rising, and keeps the oil at a proper hydraulic pressure.

The relief valve for an oil pump, which is incorporated into an engine, like this uses a structure that slidably houses a valve piston in a valve sliding path formed in a valve housing, presses the valve piston from one end side (base end side) toward the other end side (tip end side) with a spring, and presses the other end surface (tip end surface) of the valve piston against a conical seat surface formed annularly in an inner wall of a valve sliding path portion. Specifically, the relief valve has a structure such that a seat surface formed of a taper surface is provided at an outer circumferential edge of the other end surface of the valve piston, and the seat surface of the piston valve is pressed against the seat surface of the valve sliding path portion, whereby an oil inlet formed in a center of the seat surface is closed, and a release port formed in a wall surface of the valve sliding path is closed with an outer circumferential surface of the valve piston.

That is, in the relief valve, the valve piston slides in a direction to separate from the seat surface when the hydraulic pressure from the oil pump rises, by sliding of the valve piston, the inlet port formed in the center of the seat surface opens, and the oil release port opens. Thereby, the oil from the oil pump returns to an oil pan by being led out from the release port through the inlet port and the valve sliding path.

A valve opening pressure of the relief valve (valve piston) like this is set by a pressure receiving surface in the valve piston tip end and an pressing force of the spring, as is well known. In general, a set valve opening pressure is set with an entire valve piston end surface as the pressure receiving surface.

However, in the structure that regulates the valve piston by causing the conical seat surface in the valve sliding path and the seat surface formed of the taper surface in the valve piston to contact each other, the oil inlet port is formed in the center of the annular seat surface, such that a diameter of the inlet port becomes smaller than a diameter of the valve sliding path. That is, the diameter of the inlet port becomes smaller than a diameter of the end surface of the valve piston. That is, the pressure receiving surface of the valve piston at the time of the seat surface and the taper surface contacting each other is only a center portion of the end surface (tip end surface) of the valve piston, faced from the input port in the center of the annular seat surface, and is smaller than the end surface of the valve piston. An area difference of the pressure receiving surface increases a pressure fluctuation that occurs when the valve piston starts to move, and causes chattering.

That is, the valve piston cannot start to move unless a pressure lager than the set valve opening pressure is applied, since the pressure receiving surface is small at the beginning. However, the pressure receiving surface of the valve piston changes to a large pressure receiving surface that is the entire end surface of the valve piston from the pressure receiving surface with a small diameter that is an inside diameter of the inlet port, as the valve piston separates from the seat surface. When the pressure receiving area of the valve piston increases, a force that is applied to the valve piston is reduced instantaneously. Then the valve piston is returned by the elastic force of the spring before the force that is applied to the valve piston reaches the set valve opening pressure and is recovered, and causes such a behavior that the valve piston tip end collides with (contacts) the seat surface (hereinafter, the behavior will be referred to as chattering). Collision of the valve piston and the seat surface brings about generation of an unusual sound.

Therefore, conventionally, as disclosed in Patent Document 1, a stepped portion with two steps including the seal surface is formed on an outer circumferential edge portion of the tip end surface of the valve piston, a stepped portion with two steps is formed on the seat surface of the valve sliding path correspondingly to this, a position in which a small pressure receiving surface at the time of start of opening of the valve piston is switched to the large pressure receiving surface is kept away along the valve sliding path from the seat surface, and chattering of the valve piston is prevented.

### PRIOR ART DOCUMENT

### Patent Document

Patent Document 1: Japanese Utility Model Laid-Open No. 58-102870

### SUMMARY OF THE INVENTION

### Problems to be Solved by the Invention

However, in the structure in which the stepped portions with two steps are formed in the end portion of the valve piston and the seat of the valve sliding path, troublesome work for forming the step portions with two steps, that is, stepping work with high precision is required for the valve piston and the valve housing. Therefore, a cost burden is imposed, and the relief valve becomes expensive.

Therefore, an object of the present invention is to provide a relief valve capable of suppressing generation of chattering at a time of start of movement of the valve piston with a simple structure.

### Means for Solving the Problems

An aspect of the present invention includes a valve housing including an inlet into which a fluid is introduced, a valve sliding path extending from the inlet, and a release port provided in a wall surface of the valve sliding path, a valve piston slidably housed in the valve sliding path while being pressed toward an inlet side, the valve piston opening and closing the release port, and a valve stopper provided in the inlet to cross an end surface of the valve piston in a slender shape, receiving and stopping the pressed valve piston, and disposing the valve piston in a position where the valve piston closes the release port.

The valve stopper preferably includes a contact portion contacting the end surface of the valve piston in line contact.

Further, the valve stopper is preferably configured by a pin member circular in section in an axial direction.

Further, the pin member preferably crosses by passing through an axis of the valve piston.

Further, the valve sliding path is preferably formed continuously from the inlet with the same diameter as an inside diameter of the inlet, and the whole of the valve piston is preferably formed with the substantially same diameter as the inside diameter of the inlet.

Further, the release port is preferably provided in a position separated from a position where the end surface of the valve piston is received and stopped with the valve stopper, by a predetermined distance or more along the valve sliding path.

### Advantageous Effects of the Invention

According to the present invention, because of the structure that receives and stops the valve piston with the valve stopper that crosses the tip end surface of the valve piston in the slender shape, the difference between the pressure receiving area of the valve piston end facing the inlet on the valve sliding path and the pressure receiving area of the tip end surface of the valve piston can be reduced. Thereby, the difference between the pressure required at the time of start of movement of the valve piston and the set valve opening pressure of the valve piston can be reduced. The set valve opening pressure is set by the pressure receiving area and the pressing force.

Therefore, the pressure fluctuation is reduced, and chattering that occurs directly after the start of movement of the valve piston from the start of movement of the valve piston, that is, contact of the valve piston and the valve stopper can be prevented. In addition, suppression of chattering can be performed with the structure in which the valve stopper crossing the valve piston end surface in the slender shape is only provided, and troublesome highly precise work is not required. Therefore, the less expensive relief valve with low cost to be spent can be provided.

### BRIEF DESCRIPTION OF THE DRAWINGS

FIG. 1 is a sectional view illustrating a relief valve that is an aspect according to one embodiment of the present invention.

FIG. 2 is a perspective view illustrating a positional relationship between a valve piston and a valve stopper of the same relief valve.

FIG. 3A is a front view illustrating a contact state of a valve piston end and a valve stopper.

FIG. 3B is a plan view illustrating the contact state of the valve piston end and the valve stopper.

FIG. 4 is a sectional view illustrating a start of valve opening of the valve piston.

FIG. 5 is a sectional view illustrating a time at which the valve piston moves (displaces) to a fully open position.

### MODE FOR CARRYING OUT THE INVENTION

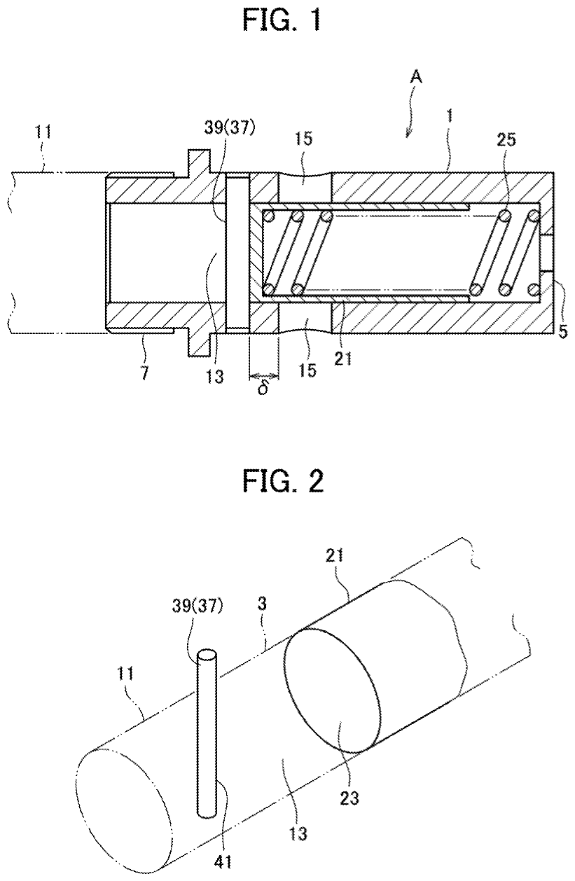

Hereinafter, the present invention will be described based on one embodiment illustrated in FIG. 1 to FIG. 5.

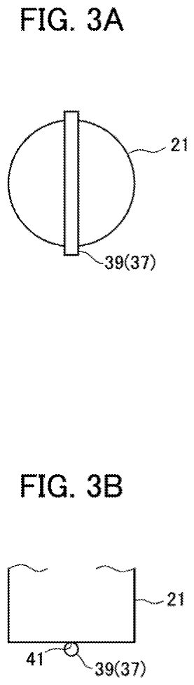

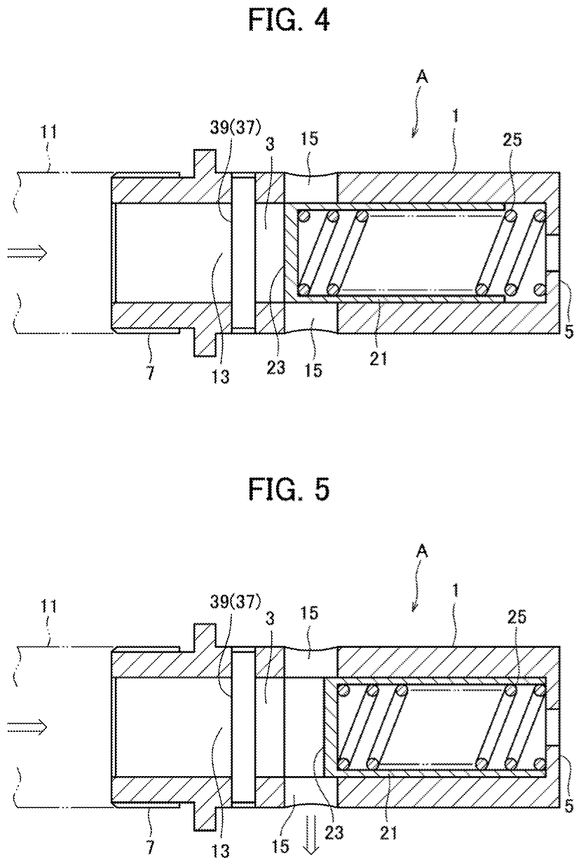

FIG. 1 illustrates a sectional view of a relief valve A that is incorporated into an engine, for example, into an outboard motor engine, FIG. 2, FIG. 3A and FIG. 3B respectively illustrate respective parts of the same relief valve A, and FIG. 4 and FIG. 5 illustrate a state from a start of valve opening to a fully open position of the same relief valve A.

The relief valve A is configured by having a cylindrical valve housing 1, a bottomed cylindrical valve piston 21, a spring 25 and a valve stopper 37, for example.

Specifically, as illustrated in FIG. 1 to FIG. 5, the valve housing 1 has a tubular, for example, cylindrical valve sliding path 3 extending along an axial direction inside the valve housing 1. The valve sliding path 3 is formed of a passage extending rectilinearly, and a spring seat 5 is formed on one end side (base end side). Further, the other end side (tip end side) of the valve sliding path 3 reaches an inner cavity of a connection port body 7 formed on a valve housing end. The connection port body 7 communicates with an oil path 11 at a downstream side (discharge side) of an oil pump (not illustrated) incorporated into a marine engine (not illustrated).

The valve piston 21 is slidably housed in the valve sliding path 3. The valve piston 21 is cylindrical, and a bottom wall portion 23 is formed of a flat wall. The bottom wall portion 23 faces a tip end side (connection port body 7 side) of the valve sliding path 3. The spring 25 is interposed between the valve piston 21 and the spring seat 5, and presses the valve piston 21 toward the tip end side (connection port body 7 side) from the base end side (spring seat 5 side) of the valve sliding path 3.

In a boundary portion between the inner cavity of the connection port body 7 and the valve sliding path 3, an inlet port 13 into which oil (fluid) from the connection port body 7 is introduced is formed. The inlet port 13 corresponds to an inlet of the present invention. The inlet port 13 is the same as a diameter of the inner cavity of the connection port body 7. With the same diameter as the inside diameter of the inlet port 13, the valve sliding path 3 extends rectilinearly from the inlet port 13. The entire valve piston 21 is formed into a straight shape with an inside diameter equivalent to the inlet port 13. A valve stopper 37 is provided in the inlet port 13 in such a manner as to cross the tip end surface of the valve piston 21. Further, a relief hole 15 formed of a pair of through-holes, for example, is provided in a wall surface of the valve sliding path 3 that is away from the inlet port 13 along the axial direction. The relief hole 15 corresponds to a release port of the present invention.

The valve stopper 37 is formed of a long and narrow member that crosses the tip end surface of the valve piston 21 in a slender shape. The valve stopper 37 receives and stops the tip end surface of the pressed valve piston 21 while securing a pressure receiving area in the tip end surface of the valve piston 21 in the inlet port 13. Details of the valve stopper 37 will be described later.

By the reception and stoppage, the valve piston 21 is positioned in which the relief hole 15 is closed, that is, a position in which the relief hole 15 is closed with the outer circumferential surface of the valve piston 21, and when the valve piston 21 moves (displaces) along the valve sliding path 3, the relief hole 15 is opened. That is, the relief hole 15 is configured to be opened and closed by sliding of the valve piston 21.

For the valve stopper 37, when the relief valve is in the closed state, a slender shape with a small diameter that linearly crosses the tip end surface of the valve piston 21 is used so that the pressure receiving area at the valve piston tip end can be secured. In particular, the valve stopper 37 uses a member having a contact portion that comes into line contact with the tip end surface of the valve piston 21, so that the pressure receiving area at the valve piston tip end can be effectively secured. For example, the valve stopper 37 is configured by a pin member 39 circular in section in an axial direction. As illustrated in FIG. 2 and FIG. 3A and FIG. 3B, the pin member 39 is disposed to pass through an axis of the valve piston 21, and cross the tip end surface of the valve piston 21, whereby an arc portion of a part of an outer circumferential surface of the pin member 39 becomes a contact portion 41, and contacts the tip end surface of the valve piston 21. That is, the valve stopper 37 receives and stops the valve piston 21 with a structure such that the valve stopper 37 is in line contact with the tip end surface of the valve piston 21, which reduces the contact area as much as possible. Thereby, the pressure receiving surface on the valve piston tip end at the time of being regulated by the valve stopper 37 (pin member 39), and a pressure receiving area (area of the entire tip end surface of the valve piston 21) of the valve piston tip end at a time of separating from the valve stopper 37 become substantially the same.

On the other hand, the relief hole 15 is disposed in a position separating from the position where the valve piston end is received and stopped by the pin member 39 by a predetermined distance or more along the valve sliding path 3. Specifically, a position where the relief hole 15 starts opening is disposed in a position that is located away from a position where the pin member 39 and the valve piston 21 are butted to each other by a predetermined distance to prevent chattering that occurs by a pressure fluctuation at a time of the relief hole 15 opening. In FIG. 1, 8 denotes the distance, that is, the distance with which chattering does not occur. The relief hole 15 communicates with an inside of an oil pan (not illustrated) of a marine engine 9.

Note that the above described relief valve (for an outboard motor engine) is used in a manner specific to the outboard motor engine, and therefore differs from an ordinary relief valve. The above described relief valve has such a structure that oil at an engine side can be returned to the oil pan through a gap of a relief valve A and holes with very small diameters (not illustrated) provided in the valve piston, with tilt up of the outboard motor engine so that maintenance work can be performed without oil flowing out into the sea, for example, when the outboard motor engine is tilted up and is put out from the sea into open air. Therefore, there is no need for a seal between the valve piston tip end and the inlet port 13.

Next, an operation of the relief valve for outboard motor engine configured in this way will be described.

When hydraulic pressure of the oil flowing in the outboard motor engine rises, the valve piston 21 of the relief valve A starts to move in a direction to separate from the pin member 39 (valve stopper 37) against the pressing force of the spring 25 as illustrated in FIG. 4. When sliding of the valve piston 21 continues, the relief hole 15 opens as illustrated in FIG. 5, and the oil from the connection port body 7, that is, the oil from the oil pump is led out to the oil pan (not illustrated) from the relief hole 15 through the inlet port 13 and the valve sliding path 3.

Here, when the pressure receiving surface of the valve piston tip end at the time of closure of the relief valve is smaller than the area of the pressure receiving surface of the valve piston tip end at the time of separating from the inlet port, the pressure required when the valve piston starts moving becomes larger than the set valve opening pressure of the valve piston. Consequently, the pressure receiving surface changes to the entire tip end surface of the valve piston, the pressure fluctuation before the pressure is recovered to the set valve opening pressure is large, and chattering occurs.

In the aspect of the present embodiment, the start of movement of the valve piston 21 of the relief valve A is performed from a state contacting the valve stopper 37 (pin member 39). The valve stopper 37 at this time is disposed to cross the tip end surface of the valve piston 21 in a slender shape, and receives and stops the tip end surface of the valve piston 21. That is, by the valve stopper 37 that crosses the valve piston end in the slender shape, the valve piston 21 stops with the structure in which the contact area is reduced more significantly than at the time of using the conventional annular seat surface, that is, a smaller contact area.

Thereby, the difference between the pressure receiving area of the valve piston 21 at the time of being disposed in the inlet port 13 and the pressure receiving area (area of the entire tip end surface) of the valve piston 21 at the time of separating from the inlet port can be reduced. In particular, when the valve stopper 37 is a member that linearly contacts the valve piston tip end surface like the pin member 39, the contact portion has an extremely small area, so that the pressure receiving area of the valve piston tip end at the time of closure of the relief valve can secure the area that does not change from the area at the time of the entire tip end surface of the valve piston 21 becoming the pressure receiving surface, that is, the area equivalent to the entire tip end surface of the valve piston 21, and the difference between the pressure receiving area of the valve piston end at the time of being disposed in the inlet port 13 and the pressure receiving area of the valve piston end at the time of separating from the inlet port 13 can be eliminated.

Accordingly, the difference between the pressure which is required at the time of the start of movement of the valve piston 21 and the set valve opening pressure of the valve piston 21 can be reduced, and the pressure variation brought about by the difference can be decreased. As described above, the set valve opening pressure is set by the pressure receiving area and the pressing force.

Therefore, chattering directly after the start of movement of the valve piston 21 from the start of movement of the valve piston 21, that is, contact of the valve piston 21 and the valve stopper 37 (pin member 39) can be prevented.

The prevention of the chattering can be performed by the structure in which the valve stopper 37 that crosses the valve piston end surface in the slender shape is only provided, and does not require troublesome high-precision work, and therefore the cost to be spent can be reduced. Therefore, the inexpensive relief valve A can be provided.

In addition, the member having the contact portion 41 which contacts the tip end surface of the valve piston 21 in line contact is used for the valve stopper 37, so that the pressure receiving area can be effectively secured. Especially in the case of the pin member 39, by applying an existing component circular in section, the pressure receiving area at the closure of the relief valve can be secured easily to such an extent that the pressure receiving area does not differ from the area of the entire tip end surface of the valve piston 21, which can greatly contribute to reduction of pressure fluctuation. In addition, the pin member 39 is disposed to cross by passing through the axis of the valve piston 21, whereby the valve piston 21 can be stably supported with the single pin member 39 which is low in cost.

The valve sliding path 3 is formed continuously from the inlet port 13 with the same diameter as the inside diameter of the inlet port 13, and a whole of the valve piston 21 is formed with the substantially same diameter as the inside diameter of the inlet port 13, so that the valve sliding path 3 and the valve piston 21 can be both formed in simple straight shapes, and the valve sliding path 3 and the valve piston 21 can be simplified. In addition, work of the valve sliding path 3 and work of the valve piston 21 can be simplified work.

In addition, the relief hole 15 is disposed in the position (position where no chattering occurs) separated from the position where the valve piston 21 is regulated with the pin member 39 (valve stopper 37) by a predetermined distance or more, whereby chattering due to the pressure fluctuation at the time of the valve piston 21 opening the relief hole 15 as illustrated in FIG. 5, that is, contact of the valve piston 21 and the valve stopper 37 (pin member 39) can be also avoided.

Note that the respective components and combinations of the components and the like in the aforementioned one embodiment are only examples, and it is needless to say that addition, omission, replacement and other changes of the components are possible within the range without departing from the gist of the present invention. Further, it is needless to say that the present invention is not limited by the aforementioned one embodiment, but is only limited by the claims. For example, in the one embodiment, the example of using the pin member circular in section as the valve stopper that crosses in the slender shape is cited, but the valve stopper is not limited to this, and may be, for example, a pin member triangular in section, a net-shaped member (net member, for example) and the like, and can be a member that is disposed to cross the tip end surface (end surface) of the valve stopper in the slender shape. Further, in the one embodiment, the present invention is applied to the relief valve which is incorporated into the marine engine, but the present invention is not limited to this, and the present invention may be applied to relief valves which are used in other apparatuses.

### EXPLANATION OF REFERENCE SIGNS

1 Valve housing
3 Valve sliding path
13 Inlet port (inlet)
15 Relief hole (release port)
21 Valve piston
25 Spring
39 Pin member (valve stopper)
41 Contact portion

1. A relief valve comprising: a valve housing including an inlet into which a fluid is introduced, a valve sliding path extending from the inlet, and a release port provided in a wall surface of the valve sliding path; a valve piston slidably housed in the valve sliding path while being pressed toward an inlet side, the valve piston opening and closing the release port; and a valve stopper provided in the inlet to cross an end surface of the valve piston in a slender shape, receiving and stopping the pressed valve piston, and disposing the valve piston in a position where the valve piston closes the release port.

2. The relief valve according to claim 1, wherein the valve stopper includes a contact portion contacting the end surface of the valve piston in line contact.

3. The relief valve according to claim 2, wherein the valve stopper is configured by a pin member circular in section in an axial direction.

4. The relief valve according to claim 3, wherein the pin member crosses by passing through an axis of the valve piston.

5. The relief valve according to claim 1, wherein the valve sliding path is formed continuously from the inlet with the same diameter as an inside diameter of the inlet, and a whole of the valve piston is formed with the substantially same diameter as the inside diameter of the inlet.

6. The relief valve according to claim 1, wherein the release port is provided in a position separated from a position where the end surface of the valve piston is received and stopped with the valve stopper, by a predetermined distance or more along the valve sliding path.

7. The relief valve according to claim 2, wherein the valve sliding path is formed continuously from the inlet with the same diameter as an inside diameter of the inlet, and a whole of the valve piston is formed with the substantially same diameter as the inside diameter of the inlet.

8. The relief valve according to claim 3, wherein the valve sliding path is formed continuously from the inlet with the same diameter as an inside diameter of the inlet, and a whole of the valve piston is formed with the substantially same diameter as the inside diameter of the inlet.

9. The relief valve according to claim 4, wherein the valve sliding path is formed continuously from the inlet with the same diameter as an inside diameter of the inlet, and a whole of the valve piston is formed with the substantially same diameter as the inside diameter of the inlet.

10. The relief valve according to claim 2, wherein the release port is provided in a position separated from a position where the end surface of the valve piston is received and stopped with the valve stopper, by a predetermined distance or more along the valve sliding path.

11. The relief valve according to claim 3, wherein the release port is provided in a position separated from a position where the end surface of the valve piston is received and stopped with the valve stopper, by a predetermined distance or more along the valve sliding path.

12. The relief valve according to claim 4, wherein the release port is provided in a position separated from a position where the end surface of the valve piston is received and stopped with the valve stopper, by a predetermined distance or more along the valve sliding path.

13. The relief valve according to claim 5, wherein the release port is provided in a position separated from a position where the end surface of the valve piston is received and stopped with the valve stopper, by a predetermined distance or more along the valve sliding path.
